(19) United States
(12) Patent Application Publication
(10) Pub. No.: US 2014/0008339 A1
(43) Pub. Date: Jan. 9, 2014

(54) METHOD AND SYSTEM FOR REMOVING MATERIAL FROM A CUT-JOINT

(71) Applicant: LINCOLN GLOBAL, INC., City of Industry, CA (US)

(72) Inventors: Jonathan S. Ogborn, Concord Twp., OH (US); Elliott Ash, Bay Village, OH (US); Edward Enyedy, Eastlake, OH (US); Michael Barrett, North Royalton, OH (US)

(73) Assignee: LINCOLN GLOBAL, INC., City of Industry, CA (US)

(21) Appl. No.: 13/796,206

(22) Filed: Mar. 12, 2013

Related U.S. Application Data
(60) Provisional application No. 61/668,859, filed on Jul. 6, 2012.

(51) Int. Cl. B23K 26/16

(52) U.S. Cl. CPC B23K 26/16
USPC 219/121.72; 219/121.67

(57) ABSTRACT

A system and method for removing material in a workpiece is provided. The system includes a laser system that melts a portion of the workpiece by heating the workpiece. The system includes a wire feeder system that feeds a wire to the workpiece to remove molten metal from the workpiece by using the wire. The wire is configured such that the molten metal adheres to the wire when the wire makes contact with the molten metal. The melting by the laser system includes a cutting or a gouging of the workpiece. In some embodiments, the system includes a hot wire power supply that supplies heating current through a length of the wire to heat the length of the wire to a desired temperature. The heating of the wire facilitates the adherence of the molten metal to the wire.

### PRIORITY

The present application claims priority to U.S. Provisional Patent Application No. 61/668,859 filed Jul. 6, 2012, which is incorporated herein by reference in its entirety.

### TECHNICAL FIELD

Certain embodiments relate to cutting and gouging applications using a laser. More particularly, certain embodiments relate to a system and method for removing material from a cut using a hot wire in laser cutting and gouging applications.

### BACKGROUND

The traditional method of cutting or gouging is to use plasma, oxyacetylene or air arc. These methods can tend to be messy as the molten material is blown away by using pressurized air or gas. In addition, these methods are limited in how deep they can cut. While laser cutting is known, the traditional method still relies on using pressurized gas to blow the molten metal away from the cutting area, which requires containment.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise a system and method for removing material from a cut using a hot wire in laser cutting and gouging applications. The system includes a laser system that melts a portion of the workpiece by heating the workpiece. The system includes a wire feeder system that feeds a wire to the workpiece to remove molten metal from the workpiece by using the wire. The wire is configured such that the molten metal adheres to the wire when the wire makes contact with the molten metal. The melting by the laser system includes a cutting or a gouging of the workpiece. In some embodiments, the system includes a hot wire power supply that supplies heating current through a length of the wire to heat the length of the wire to a desired temperature. The heating of the wire facilitates the adherence of the molten metal to the wire.

The method includes melting a portion of the workpiece by heating the workpiece using a laser and feeding a wire to the workpiece to remove molten metal from the workpiece by using the wire. The wire is configured such that the molten metal adheres to the wire when the wire makes contact with the molten metal. In some embodiments, the method further includes supplying a heating current through a length of the wire to heat the length of the wire to a desired temperature. The heated wire facilitates the adherence of the molten metal to the wire.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a functional schematic block diagram of an exemplary embodiment of a system for laser cutting and gouging applications;

FIG. 2 illustrates an exemplary embodiment of a wire feeder that can be used in the system of FIG. 1;

FIG. 3 illustrates an exemplary embodiment of a wire feeder that can be used in the system of FIG. 1;

FIG. 4 illustrates an exemplary embodiment of a wire feeder that can be used in the system of FIG. 1;

FIGS. 5A and 5B illustrate exemplary embodiments of contact tubes that can be used in the system of FIG. 1; and

FIGS. 6A and 6B illustrate exemplary embodiments of hot wires that can be used in the system of FIG. 1.

### DETAILED DESCRIPTION

Exemplary embodiments of the invention will now be described below by reference to the attached Figures. The described exemplary embodiments are intended to assist in the understanding of the invention, and are not intended to limit the scope of the invention in any way. Like reference numerals refer to like elements throughout.

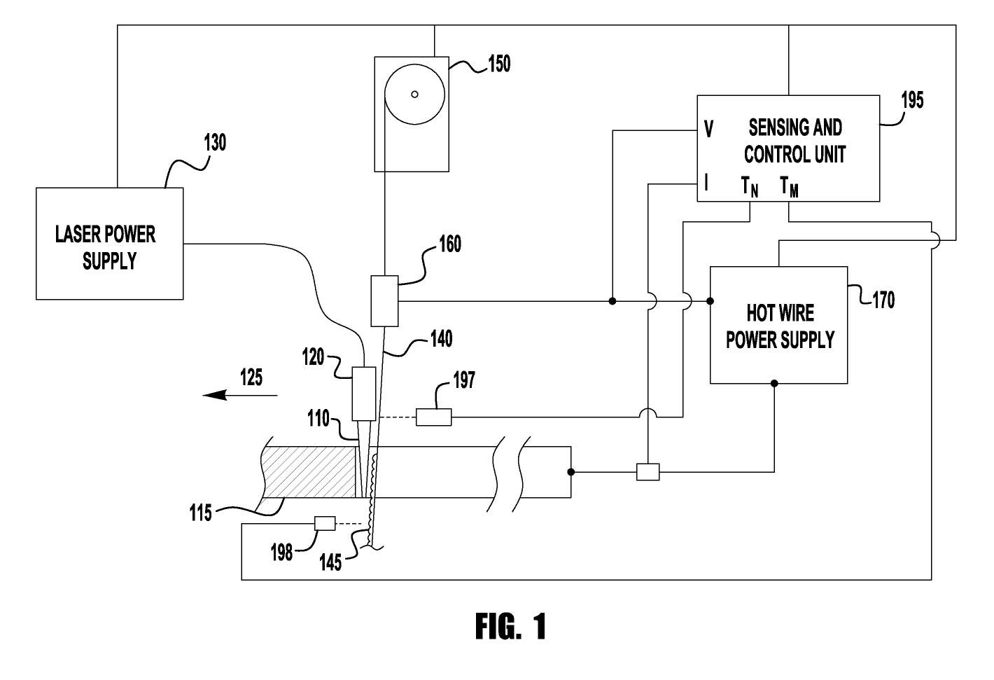

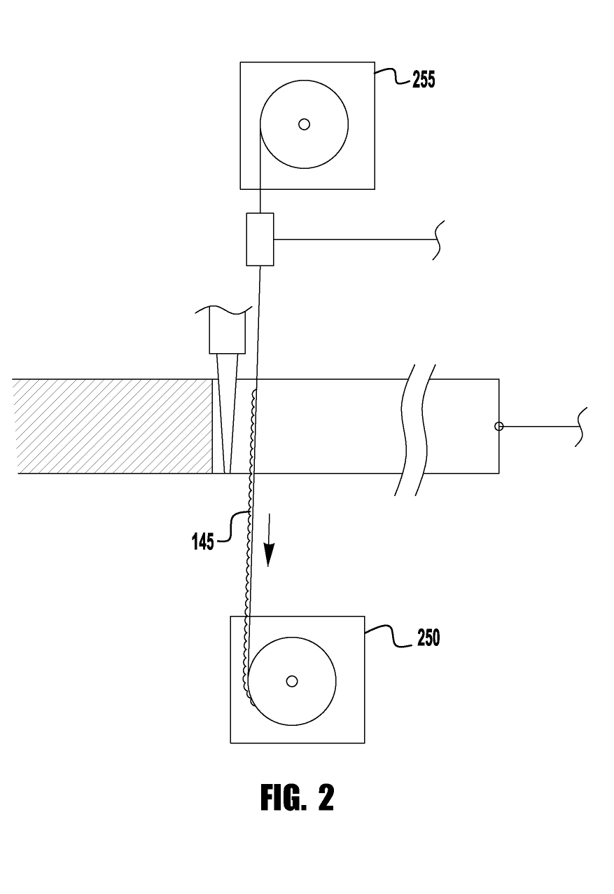

FIG. 1 illustrates a functional schematic block diagram of an exemplary embodiment of a system 100 for performing cutting and gouging applications. The system 100 includes a laser subsystem capable of focusing a laser beam 110 onto a workpiece 115 to heat a portion of the workpiece 115. The laser subsystem is a high intensity energy source. The laser subsystem can be any type of high energy laser source, including but not limited to carbon dioxide, Nd:YAG, Yb-disk, YB-fiber, fiber delivered or direct diode laser systems. Further, even white light or quartz laser type systems can be used if they have sufficient energy. For example, a high intensity energy source can provide at least 500 W/cm².

The following exemplary embodiments will be discussed in terms of cutting operations. However, one skilled in the art will understand that the present invention is not limited to just cutting operations and that other operations, including gouging operations, can fall within the scope of the present invention.

The laser 120 should be of a type having sufficient power to provide the necessary energy density for the desired cutting operation. That is, the laser device 120 should have a power sufficient to melt workpiece 115 throughout the cutting process, and also reach the desired penetration. For example, lasers should have the ability to “keyhole” the workpieces being welded. This means that the laser should have sufficient power to fully penetrate the workpiece, while maintaining that level of penetration as the laser travels along the workpiece. Exemplary lasers should have power capabilities in the range of 1 to 20 kW, and may have a power capability in the range of 5 to 20 kW. Higher power lasers can be utilized, but can become very costly.

As shown in FIG. 1, the laser subsystem 130/120 includes a laser device 120 and a laser power supply 130 operatively connected to each other. The laser power supply 130 provides power to operate the laser device 120. The laser beam 110 serves to cut workpiece 115 by melting some of the base metal of the workpiece 115.

The system 100 also includes a hot wire feeder subsystem capable of providing at least one wire 140 to make contact with molten material 145 in workpiece 115 in the vicinity of the laser beam 110. The hot wire feeder subsystem includes a wire feeder 150, a contact tube 160, and a hot wire power supply 170. During operation, the wire 140, which trails the laser beam 110 as it moves in direction 125, is heated by the hot wire power supply 170 which is operatively connected between the contact tube 160 and the workpiece 115. As illustrated in FIG. 1, the power supply 170 can supply current to heat wire 140. In accordance with an embodiment of the present invention, the hot wire power supply 170 is a pulsed direct current (DC) power supply, although alternating current (AC) or other types of power supplies are possible as well.

The wire 140 is fed from the wire feeder 150 through the contact tube 160 toward the workpiece 115 and extends beyond the tube 160. The extension portion of the wire 140 is heated such that the extension portion is at or near (including above and below) the melting point of workpiece 115 before contacting the molten material 145 on the workpiece 115. As indicated above, in this exemplary embodiment the hot wire power supply 170 provides a heating current to the wire 140. The current flows in wire 140 between the contact tip 160 (which can be of any known construction) and the workpiece 115. This resistance heating current causes the wire 140 between the contact tube 160 and the workpiece 115 to reach a temperature that is at or near (including above and below) the melting temperature of the workpiece 115. Of course, the melting temperature of the workpiece 115 will vary depending on the size and chemistry of the workpiece 115. Accordingly, the desired temperature of the wire 140 during cutting will vary depending on the workpiece 115. In exemplary embodiments, the temperature of the wire 140 is within ±25% of the melting point of workpiece 115. The desired operating temperature for the wire 140 can be a data input into the cutting system so that the desired wire temperature is maintained during cutting. In any event, the temperature of the wire 140 should be such that the wire 140 is always below its melting point during the cutting operation. In exemplary embodiments, the wire 140 is 5 to 45% below its melting point. The power supply 170 provides a large portion of the energy needed to heat the wire 140. However, the laser beam 110 may aid in the heating of wire 140.

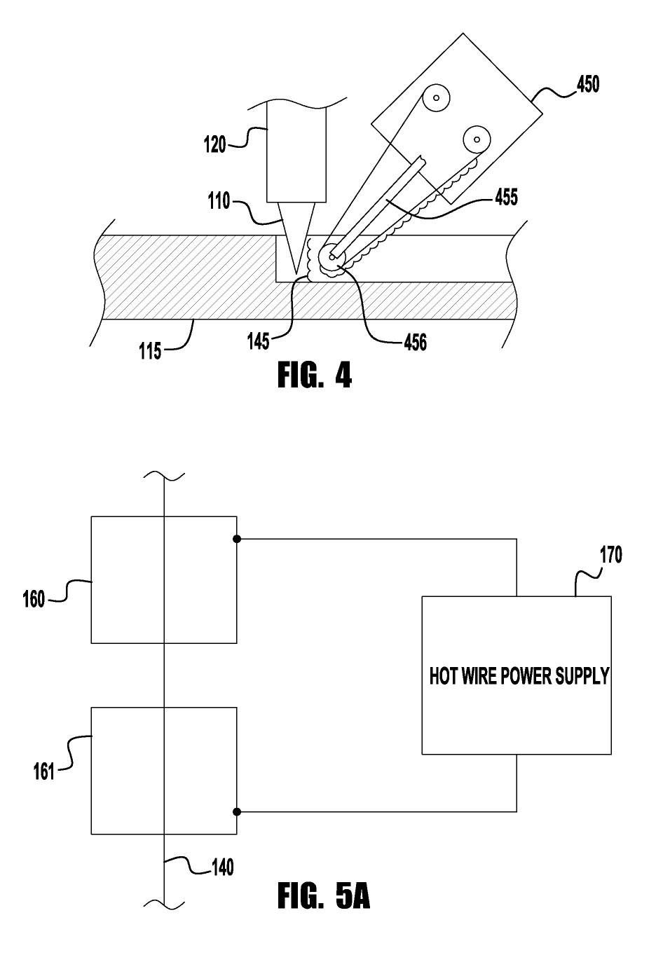

In the above embodiments, the heating current in wire 140 flows between the tip of contact tube 160 and workpiece 115, where at least a portion of the wire 140 contacts the workpiece during the cutting operation. However, in some exemplary embodiments, as shown in FIG. 5A, the wire 140 is routed through two contact tubes 160 and 161. In these embodiments, the heating current in wire 140 flows between the contact tubes 160 and 161. Further, in other exemplary embodiments, as shown in FIG. 5B, the contact tube 160 contains an induction coil 165, which causes the contact tube 160 and the wire 140 to be heated via induction heating. In such an embodiment, the induction coil 165 can be made integral with the contact tube 160 or can be coiled around a surface of the contact tube 160. Of course, other configurations for heating wire 140 can be used so long as they deliver the needed heating current/power to the wire 140 so that the wire can achieve the desired temperature for the cutting operation.

During cutting operations, the laser beam 110 will initially melt a portion of workpiece 115 to create a hole or slot in the workpiece 115. Once the laser beam 110 fully penetrates the workpiece 115, the wire 140 is fed by wire feeder 150 through the hole or slot created by the laser beam 110. As the wire 140 moves through the hole or slot, the wire 140 picks up the molten metal 145 and the molten metal 145 is removed from the hole or slot. That is, during cutting the molten material from the workpiece adheres to the surface of the 140 and the wire 140 carries the material out of the cutting area in a controlled fashion. As such, the temperature of the wire should be such that it allows the molten material from the workpiece to adhere to the wire 140. Thus, in some exemplary embodiments the wire 140 does not have to be heated and can simply be at room or operational temperature. This temperature will allow the molten material to quickly cool and adhere to the surface of the wire 140. However, to the extent that the material is to be removed from the wire 140, it can be beneficial to have the wire 140 heated as described herein. This will be discussed further below.

By using the wire 140 rather than blasting the molten metal 145 using pressurized gas, the work area is kept clear of debris. As the wire 140 draws out the molten metal, the laser 120 and/or the workpiece 115 is moved as desired to cut the remaining portion of workpiece 115. U.S. patent application Ser. No. 13/212,025, titled “Method And System To Start And Use Combination Filler Wire Feed And High Intensity Energy Source For Welding” is incorporated by reference in its entirety, provides exemplary robotic systems that may be used for moving workpiece 115.

As discussed before, in some exemplary embodiments the wire 140 is preheated to at or near the temperature of the meting point of workpiece 115. In these embodiments, by preheating the wire 140, the wire 140 will not appreciably cool or solidify the molten metal 145 as the wire 140 draws the molten metal 145 out of the cut. However, the temperature of the wire 140 should be such that at least some bonding between the molten metal and the wire surface should occur. Depending on the properties of the workpiece 115 being cut and the wire 140, in some exemplary embodiments, the temperature of the wire 140 may be kept slightly below the melting point of wire 140. In such embodiments, the wire has a melting temperature which is higher than that of the workpiece being cut. In some exemplary embodiment, the melting temperature of the wire 140 is at least 5% higher than that of the workpiece being cut. As such, the portion of molten metal 145 that touches wire 140 may solidify and facilitate the adherence of the molten metal 145 to the wire 140 as the metal 145 is being drawn out of the hole or slot. In other embodiments, the removal of the molten metal 145 may be easier if the metal 145 is kept molten on the wire 140. In such cases, the temperature of wire 140 may be kept slightly higher than the melting point of workpiece 115. Because the wire 140 is used to remove the molten metal 145, as opposed to pressurized air or gas, the workpiece 115 is clear of molten debris.

In the embodiments discussed above, the wire 140 is pushed through the hole or slot by wire feeder 150. As such, the wire 140 should be of a sufficient rigidity that it can be forced through the hole or slot without bending or crimping when drawing out the molten metal 145. Further, the contact tip 160 can be of a configuration that controls the movement and placement of the wire 140 through the cut and keeping the wire 140 in the appropriate positioning. However, the present invention is not limited to wire feeders that push the wire 140 through the hole or slot, and can include wire feeding systems that pull the hot wire through the hole or slot instead of pushing it. The wire 140, which is initially spooled on spooler 255, is drawn through the hole or slot by wire feeder 250. In this case, the wire 140 need not be as rigid as in the above embodiments (but should have the proper tensile strength) and, thus, can be thinner. By using a thinner wire 140, the slots (or holes) relatively narrower slots and smaller holes can be formed by laser beam 110 in the workpiece 115. Of course, in the case of a hole or a slot that is initiated in the middle of the workpiece 115 (as opposed to starting from an edge of the workpiece 115), the wire 140 will first have to be threaded through the hole or slot to wire feeder 250 before it can start its pulling operation.

In the above embodiments, the wire feeding operations are a once-though process in that the wire 140 is not reused during the same cutting operation. Of course, the metal 145 that has adhered to the wire 140 may be removed from the wire 140 at a later time, and the wire 140 can then be reused. For example, in some exemplary embodiments, the metal 145 can be removed by heating wire 140 to a point where the metal 145 melts off the wire 140. This is possible because the melting point of the wire 140 is higher than that of the metal 145 that was removed from the workpiece 115. In other exemplary embodiments, the metal 145 can be chemically removed using chemicals that react with metal 145 but not with wire 140. In yet other exemplary embodiments, the metal 145 can be mechanically removed, for example, by scraping or grinding of the metal 145 from the wire 140. Of course, any combination of the above cleaning methods may be used in the present invention.

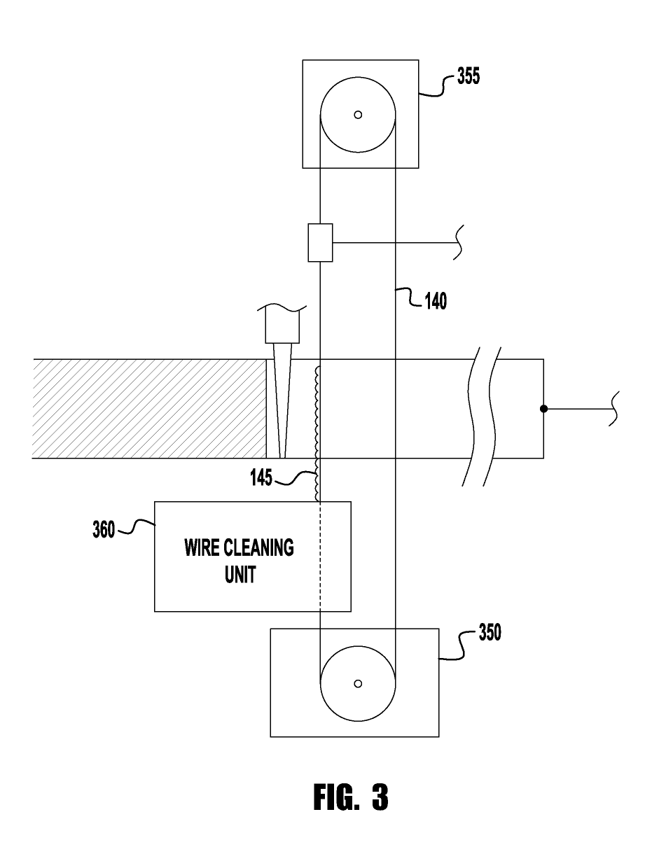

The once-through wire feed process discussed above will require that enough wire 140 is spooled or kept on-site to ensure that the cutting operation is not interrupted. However, the present invention is not limited to just the once-through wire feed process and other wire feed processes may be used. For example, FIG. 3 illustrates an embodiment in which the wire 140 is looped between a wire feeder 350 and pulley 355. In this exemplary embodiment, wire feeder 350 pulls the wire 140 from pulley 355 through the hole or slot in workpiece 115 and then through the wire cleaning unit 360 before the wire 140 is looped back to pulley 355. In this embodiment, after the wire 140 picks up the molten metal 145 during the cutting operation, the metal 145 is removed from the wire 140 by the wire cleaning unit 360. The wire 140 is then routed to the pulley 355 by the feeder 350 so that the wire 140 can be reused. The wire cleaning unit 360 can use any combination of the exemplary cleaning methods discussed above to clean the wire 140. However, in this case, the cleaning is performed during the cutting operation, rather than using the “offline” cleaning method discussed above. Because the wire 140 can be immediately reused, there is no need to keep a large amount of the wire 140 on-hand for cutting operations.

For example, the wire cleaning unit 360 can use additional heat which heats the removed material and/or the wire to above the melting temperature of the workpiece so that any solidified material 145 will be in molten form again. Once made molten, the material can then be removed by scraping or other physical means. Additionally, the wire cleaning unit can use a chemical bath to clean the material off of the wire 140.

In the above embodiments, the laser beam 110 fully penetrates the workpiece 115 during cutting operations. However, the laser device 120 allows for precise control of the size and depth of the cutting, as it is easy to change the focus and beam intensity on laser 120. Accordingly, in some embodiments, the laser 120 may be controlled such that the beam 110 does not fully penetrate the workpiece 115 during cutting operations. In such cases, the wire 140 must return to the same side of the workpiece 115 after picking up the molten material 145, as illustrated in FIG. 4. As shown in FIG. 4, wire feeder 450 includes extension 455 and pulley 456 that permits the wire 140 to remove the molten material 145 from the cutting area and return it to wire feeder 450 (or send it to some other location). The wire 140 may be heated using methods discussed above. In addition, the wire 140 may be directed to a wire cleaning system similar to that discussed above prior to returning the wire 140 to the wire feeder 450 for reuse. Because the shape and/or intensity of the beam 110 can be adjusted/changed, in some exemplary embodiments the width and depth of the cut may be varied as desired during the cutting process. Of course, wire feeder 450 may also be used in cutting operations that fully penetrate the workpiece 115. For example, in situations where it is impractical to have wire feeder equipment on both sides of the workpiece 115, wire feeder 450 will be able to remove the molten metal 145 from the cut. These embodiments allow groves and channels to be cut in a work piece and allows for the simultaneous removal of excess material, allowing for rapid and clean processing of the workpiece.

In the embodiments discussed above, the wire 140 can be a material that has a higher melting temperature than workpiece 115. For example, in the case where aluminum is the workpiece 115, the wire 140 can be a metal alloy, such as steel, that has a higher melting temperature. Of course other wire/workpiece material combinations can be used so long as the melting point of the wire is higher than the melting point of the workpiece 115.

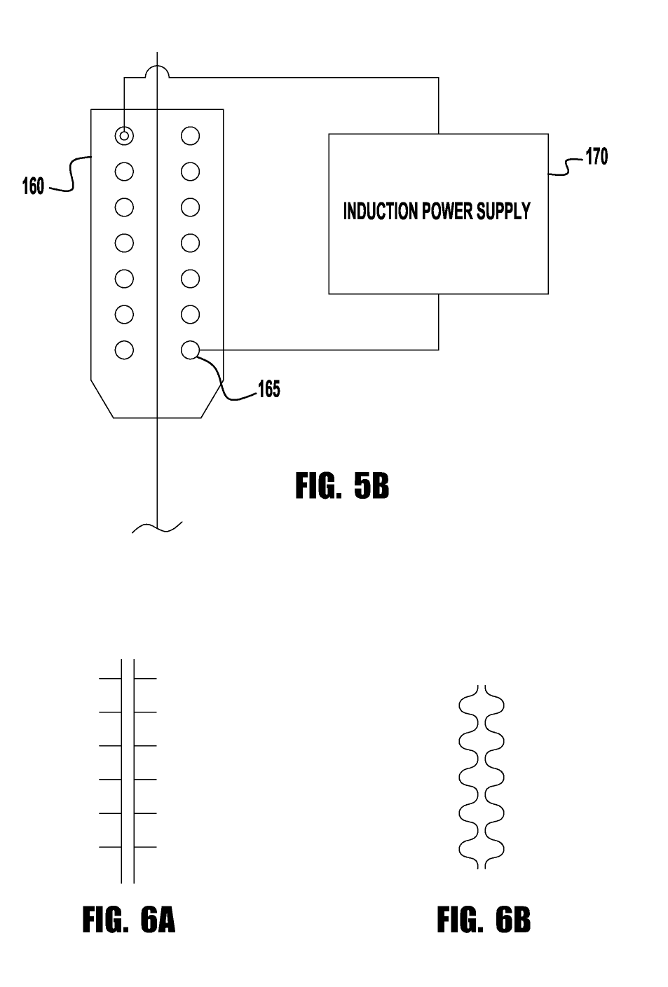

In addition, to facilitate the removal of molten metal 145, the wire 140 may be knurled. A knurled wire will allow the wire 140 to grab and attach to the molten metal 145 more easily. Some exemplary embodiments of such knurled wire 140 are illustrated in FIGS. 6A and B. That is, the surface of the wire 140 can be textured, have protrusions, grooves, abrasive, etc. which provides additional surface area of the material to be removed.

In another exemplary embodiment of the present invention, the wire feeders 150, 250, 350, and 450 (or the sensing and control unit 195) can include or be coupled to a feed force detection unit (not shown). The feed force detection units are known and detect the feed force being applied to the wire 140 as it is being fed to the workpiece 115. For example, such a detection unit can monitor the torque being applied by a wire feeding motor in the wire feeder 150, 250, 350, and 450. If the wire 140 encounters obstacles as it passes through the molten metal 145 because of, for example, un-melted areas on workpiece 115, such contact can cause an increase in the force/torque of the motor that is trying to maintain the desired wire feed rate. This increase in force/torque can be detected and relayed to the control 195 which can utilize this information to adjust the voltage, current and/or power to laser power supply 130 to ensure proper melting of the workpiece 115, to wire feeder 150, 250, 350, or 450 to ensure proper wire speed, and/or to power supply 170 to ensure proper temperature of the wire 140. To this end, sensing and control unit 195 may use the temperature feedbacks from sensors 197 (temperature of wire 140) and 198 (temperature of molten metal 145) to further adjust the voltage, current and/or power to laser power supply 130, wire feeder 150, 250, 350, or 450, and/or power supply 170. U.S. patent application Ser. No. 13/212,025, titled “Method And System To Start And Use Combination Filler Wire Feed And High Intensity Energy Source For Welding” and incorporated by reference in its entirety, provides exemplary temperature sensors and control algorithms that may be used in the above exemplary systems for controlling the temperature of the wire 140.

In FIG. 1, the laser power supply 130, hot wire power supply 170, and sensing and control unit 195 are shown separately for clarity. However, in embodiments of the invention these components can be made integral into a single welding system. Aspects of the present invention do not require the individually discussed components above to be maintained as separately physical units or stand alone structures.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A system for removing material in a workpiece, said system comprising:
a laser system that melts a portion of said workpiece by heating said workpiece; and
a wire feeder system that feeds a wire to said workpiece to remove molten metal from said workpiece by using said wire;
wherein said wire is configured such that said molten metal adheres to said wire when said wire makes contact with said molten metal, and
wherein said melting by said laser system comprises a cutting or a gouging of said workpiece.

2. The system of claim 1, further comprising:
a hot wire power supply that supplies heating current through a length of said wire to heat said length of said wire to a desired temperature,
wherein said desired temperature facilitates said adherence of said molten metal to said wire.

3. The system of claim 2, wherein said desired temperature is ±25% of a melting temperature of said workpiece.

4. The system of claim 2, wherein said desired temperature is above a melting temperature of said workpiece.

5. The system of claim 2, wherein said desired temperature is below a melting temperature of said workpiece.

6. The system of claim 1, wherein a melting temperature of said wire is at least 5% above a melting temperature of said workpiece.

7. The system of claim 1, wherein said wire feeder system is a once-through system that does not reuse said wire in a same melting process.

8. The system of claim 1, wherein said wire feeder system is a loop-back system that reuses said wire in a same melting process.

9. The system of claim 8, further comprising:
a cleaning unit that uses one of a mechanical and chemical process to clean said adhered metal from said wire prior to said reuse.

10. The system of claim 1, wherein said wire is knurled to facilitate removal of said molten metal.

11. A method of removing material in a workpiece, said method comprising:
melting a portion of said workpiece by heating said workpiece using a laser; and
feeding a wire to said workpiece to remove molten metal from said workpiece by using said wire;
wherein said wire is configured such that said molten metal adheres to said wire when said wire makes contact with said molten metal, and
wherein said melting comprises a cutting or a gouging of said workpiece.

12. The method of claim 11, further comprising:
supplying a heating current through a length of said wire to heat said wire to a desired temperature,
wherein said desired temperature facilitates said adherence of said molten metal to said wire.

13. The method of claim 12, wherein said desired temperature is ±25% of a melting temperature of said workpiece.

14. The method of claim 12, wherein said desired temperature is above a melting temperature of said workpiece.

15. The method of claim 12, wherein said desired temperature is below a melting temperature of said workpiece.

16. The method of claim 11, wherein a melting temperature of said wire is at least 5% above a melting temperature of said workpiece.

17. The method of claim 11, wherein said wire is not reused in a same melting process.

18. The method of claim 11, wherein said wire is reused in a same melting process.

19. The method of claim 18, further comprising:
cleaning adhered metal from said wire by using one of a mechanical and chemical process prior to said reusing of said wire.

20. The method of claim 11, wherein said wire is knurled to facilitate removal of said molten metal.
